(19) United States
(12) Patent Application Publication
(10) Pub. No.: US 2025/0376015 A1
(43) Pub. Date: Dec. 11, 2025

(54) Systems and Methods for Folding and Rolling of Covering Materials for Storage or Transport

(71) Applicants: Curtis Anderegg, Clifton, TN (US); Sarah Anderegg, Clifton, TN (US); Jesse Rosenecker, Waynesboro, TN (US)

(72) Inventors: Curtis Anderegg, Clifton, TN (US); Sarah Anderegg, Clifton, TN (US); Jesse Rosenecker, Waynesboro, TN (US)

(21) Appl. No.: 19/207,646

(22) Filed: May 14, 2025

Related U.S. Application Data
(60) Provisional application No. 63/658,849, filed on Jun. 11, 2024.

(51) Int. Cl. B60J 7/08; B60J 7/10; B65H 18/04

(52) U.S. Cl. CPC B60J 7/085; B60J 7/102; B65H 18/04

(57) ABSTRACT

The present disclosure relates to a device for assisting in the folding and rolling of a tarp. The device comprises a frame and a tarp rotator. The frame may be adapted for mounting on the edge of a flatbed trailer, for example mounted on a rub rail on the edge of the trailer. The frame includes releasable attachments for supporting the tarp rotator offset from the edge of the trailer and allowing rotation of the tarp rotator. A tarp may be prepared by producing a fan fold configuration and inserting into a receiving gap in the tarp rotator. The tarp rotator may then be rotated to wind the tarp around the tarp rotator. The tarp rotator with rolled tarp thereon may then be released from the frame and transferred to the trailer whereupon the tarp rotator is removed from the tarp, thus producing a completed rolled tarp ready for storage.

### RELATED APPLICATIONS

This application claims the benefit under 35 USC 119(e) of provisional application Ser. No. 63/658,849, titled: “Systems and Methods for folding and rolling of covering materials for storage or transport”, filed Jun. 11, 2024 by Anderegg et al.

All of the above listed US patent and patent applications are hereby incorporated herein by reference in their entirety.

### BACKGROUND

### Field of the Invention

The present disclosure relates to a device and method to assist in the folding and rolling of a tarp or covering for storage, more particularly for tarps used to cover items in transport on flat bed trailers or trucks.

### Background Discussion

Tarps are frequently used for covering loads transported by trucks on highways, in particular, flatbed trucks have no enclosure and the loads may be exposed to the elements including rain, snow, dust, gravel, wind. Further, the tarps may provide some confidentiality to the load hiding the apparent value and nature of the load. The tarps are typically multi-use, and are of heavy construction to withstand multiple deployments and rough usage. Thus, they may be quite heavy and repeated handling of these heavy tarps pose difficulties and lead to muscle strain for many drivers. The trucking industry employs a wide variety of drivers in terms of size and build. Not all drivers are of the football linebacker build to handle large tarps with ease. Many drivers are small in frame, many are older, over 50, over 65. Some may have physical limitations including back problems. More and more women are drivers and may have smaller, lighter frames. A typical tarp may be 16×20 feet (5×7 meters) and may weigh 80 lbs (40 kg). A typical trucking run may use 1 to 6 tarps. Each must be folded and stowed after the run. A typical prior art process of folding is entirely manual and involves stretching the tarp on the ground and folding each corner over to its corresponding corner and straightening the edge to align it all along the edge, walking the length and bending over to make adjustments. Then repeat folding the new corners and aligning the new edges, and repeating until the tarp is a narrow full-length strip, then making length wise folds or rolls to the final compact configuration. Then binding the tarp with an elastic strap, bungee cord ready for stowage. Then lifting the tarp from the ground up to the flat bed for stowage for the trip back. The folding process must be repeated for each tarp and can be a challenging and can take a physical toll, especially in combination with back issues or light frame and older drivers. Thus, there is a need for devices and methods to assist in the tarp preparation and stowage process.

### BRIEF DESCRIPTION

The present disclosure relates to a device and/or system for assisting in the folding and rolling of a tarp. The device comprises a frame and a tarp rotator assembly, alternatively, tarp rotator. The frame may be adapted for mounting on the edge of a flatbed trailer. The frame includes releasable attachments for supporting the tarp rotator offset from the edge of the trailer and allowing rotation of the tarp rotator. A tarp may be prepared by folding in fan fold configuration and inserted into a receiving gap in the tarp rotator. The tarp rotator may then be rotated to wind the tarp around the tarp rotator. The tarp rotator with rolled tarp thereon may then be released from the frame and transferred to the trailer whereupon the tarp rotator is removed from the tarp, thus producing a completed rolled tarp ready for storage.

An exemplary device may comprise a frame adapted for mounting on a rub rail of a flatbed truck or trailer.

A rub rail is commonly supplied as part of a trailer, in particular, a flatbed trailer. An exemplary rub rail may be a wide heavy metal band at the top edge of the trailer, even with the top of the trailer and spaced from the trailer with periodic spacers, leaving space between the rub rail and trailer for running tie downs, cables, and chains to run through the space to anchor points below. In addition, the rub rail may be used for directly anchoring to the rub rail or spacer. The rub rail and spacers are typically welded to the trailer.

In one embodiment, the device may be configured to utilize the space between the rub rail and the flat bed and may rest on top of the edge of the rub rail. The frame may have arms extending from the rub rail to hold the tarp rotator assembly.

In one embodiment, the mounting frame may be securely attached to said trailer. The attachment may include, for example, clamps, bolts, glue, or welding.

In one embodiment, the frame may comprise arms adapted for mounting on the trailer on a first end and having a releasable attachment on the second end for attaching the tarp rotator assembly and allowing rotation of the tarp rotator assembly.

In operation, the tarp may be prepared for rolling by folding the tarp into a narrow length wise fan fold configuration. One end of the pre-folded tarp may then be inserted into the tarp rotator, extending sufficiently to engage the rolling operation. The insertion may be, for example one foot, or other distance, as desired. The handle may then be used to rotate the tarp rotator and roll the tarp to wrap the tarp around the tarp rotator. The process simultaneously and incrementally lifts the tarp to the level of the flat bed. The tarp may then be wrapped with an elastic band, e.g., a bungee cord, as desired to stabilize the wrap. The tarp rotator may then be released from the releasable attachments of the arms and the tarp rotator with the tarp may then be transferred to the flatbed. Any lifting at this stage would be substantially shorter and easier than a lift from the ground and would be starting at a level at or near the level of the flatbed, thus requiring much less back bending and stress compared to a lift from ground level. In one embodiment, the arm and attachment may include a slot tilted toward the flatbed to further facilitate the transfer onto the flatbed. In a further variation, the arms may be angled to position the tarp rotator above the flatbed to further assist in the transfer of the tarp onto the flatbed.

In a further variation, the arms and tarp rotator may include a ratchet and pawl or other stop mechanism to limit unwinding after wrapping while the elastic band is being installed. In an alternative, a disk with periodic holes around the circumference may be fixedly attached to the arm and a pin may be inserted through a hole in the crank arm to engage one of the holes in the disk to stop the rotation. Alternatively, the disk may be fixed to the crank and the arm may have a hole for receiving the pin.

In a further variation, the tarp may be prepared by folding in multiple parallel folds or rolls to reduce a tarp width to fit the tarp rotator.

In a further variation, the device may include a rod preferably attached to the device to assist in preparation of the tarp for rolling. In one embodiment, the rod may be in the shape of an S-hook. The tarp may include gromets along the edges, spaced typically two to three feet apart. The gromets may be used with the rod for folding the tarp in an accordion fold arrangement. To assist, a further accessory may be included as a second rod, preferably with a T handle for use in forming the accordion fold. In operation, the first rod is attached to the flat bed, in particular, to the frame by inserting one end through a hole in the frame for receiving the rod. The tarp may then be spread in the ground with one edge near the rod. The gromets may then be placed on the rod, preferably starting with a center gromet and then in sequence in one direction, then the other direction until all desired gromets are inserted. This begins a fan fold, or accordion fold, on one end. The operator then goes to the other end and using the T-handle rod, or hook shaped rod, assembles the gromets onto the T-handle rod on the other end. The T-handle rod may then be used to lift the tarp from the far end and stretch the tarp. In so doing, the tarp may drape between the gromets and form the accordion fold for the length of the tarp. The tarp may be dragged or shaken from side to side to help with the alignment of the folds. The accordion fold assembly may then be placed flat ways on the ground at the far end and the near end may then be removed from the rod and inserted into the tarp roller assembly. The tarp end is inserted between the tines a foot or more, as desired, and allowed to drape across one tine of the fork. The tarp rotator may then be turned by the handle to wind the tarp onto the rotator unit. The T-handle rod may be removed at any convenient time. The accordion fold operation allows the device and the resulting rolled tarp to be a small fraction of the open width dimension of the tarp. A typical exemplary 16 foot wide tarp may have five gromets along the side dividing the edge into four segments four feet each. Thus, the accordion fold reduces the width to a folded width of two feet nominal for insertion into the rolling device.

Depending on the particular tarp and available gromets, other gromet spacings or sequences may be used to obtain the desired fold dimension. For example, every other gromet may be selected for attaching to the S-hook and T handle hook.

In one embodiment, the frame includes a release system allowing removal of the tarp rotator assembly. After the tarp is rolled onto the tarp rotator, the tarp rotator with rolled tarp may be released and removed from the frame and transferred to the flatbed.

In one embodiment, the tarp rotator may comprise two parts, which may be separated without the use of tools, allowing the tarp rotator to be removed from the tarp, leaving the rolled tarp ready for storage.

In one embodiment, the release system may comprise a release pin, which may be a spring loaded pin for each arm, each spring loaded pin having a locked position and a release position. In the locked position, each spring loaded pin retains a respective rotator shaft within a respective bearing structure of the frame. In the release position, each spring loaded pin allows removal of the respective shaft of the rotator assembly.

In a further feature of the invention, the device may be folded for compact storage in a tool box or bag and placed conveniently in a storage bin for travel. The device being sufficiently compact so as to be included among the truck equipment without displacing other essential tools and equipment. The spacing link includes rotatable fasteners at the mounting arm connections and the center of the link. Thus, the link may be folded on itself bringing the two arms together and parallel to form a compact configuration occupying a fraction of the space (L×W×H), that would be required for the full device in the mounting configuration. An advantage of using the rotatable fasteners as compared with removable fasteners is that the parts may be kept together for storage to minimize the chance of lost parts.

In addition, the tarp rotator assembly may be disassembled to separate the rotator fork unit from the tine coupling unit to reduce overall length for simpler storage.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of an exemplary device mounted on a flatbed trailer.

FIG. 2 is a side view of an exemplary first arm assembly of the device.

FIG. 3 is a perspective view of a frame structure of the device.

FIG. 4 is an exploded side view of the tarp rotator assembly.

FIG. 5 is a side view of an exemplary S-hook.

FIG. 6 is a side view of an exemplary T-handle hook.

FIG. 7 is a view of the S-hook with tarp and gromets installed on a trailer rub rail.

FIG. 8 is a view of an exemplary accordion fold stretch configuration.

FIG. 9 is a view of the tarp stretched between the S-hook and T-handle hook.

FIG. 10 is a view of the device with tarp inserted showing drape section.

FIG. 11 is a view of the exemplary tarp roller device with the tarp rolling completed.

FIG. 12 is a view of the rolled tarp and rotator assembly removed from the arms of the frame and placed on the flatbed.

### DETAILED DESCRIPTION

The present disclosure relates to a device for assisting in the folding, rolling, and lifting of a tarp for stowing after the tarp has been used for covering an object in transit.

The present disclosure describes an embodiment of the invention with respect to an exemplary installation on a truck or trailer flatbed. It can be appreciated that the device may be used with trucks, trailers, and other structures as desired, as well as other than flatbed trailers. The device enables a process of first folding the tarp into a lengthwise fan fold, or alternatively referred to as an accordion fold configuration. Then, the fan fold tarp end is inserted into the device rotator assembly, alternatively referred to as tarp rotator, or rotator. The rotator is then rotated to wind the tarp around the rotator while simultaneously lifting the tarp to the flatbed level. An elastic band may be used to wrap the rolled tarp. Then, the rolled tarp may be transferred to the flatbed.

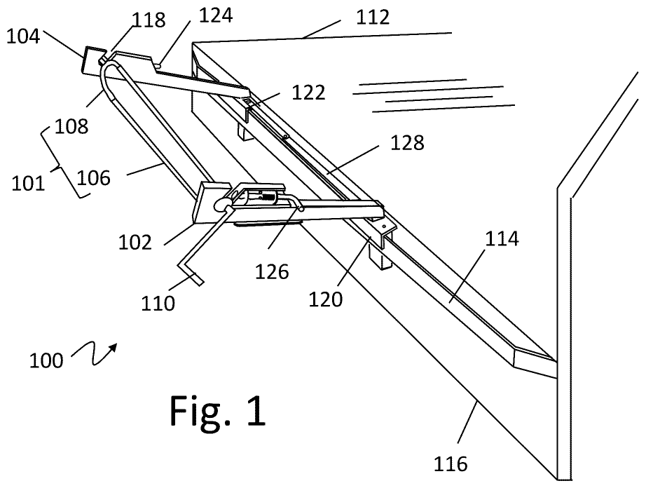

FIG. 1 is a perspective view of an exemplary device mounted on a flatbed trailer. Referring to FIG. 1, the tarp roller device 100, alternatively referred to as device, comprises a frame and a tarp rotating assembly 101 releasably mounted thereon. The frame may be mounted on a supporting structure. In particular, the frame may be adapted to mount on a flatbed trailer. In one embodiment the frame may be mounted on a rub rail 114 structure of a flatbed trailer 112. The frame comprises a first arm 102, a second arm 104 and a spacer link 128 therebetween. Each arm 102, 104 may include a mounting structure 120. In one embodiment, the mounting structure 120 may be adapted to fit over the rub rail 114 and between the rub rail 114 and side of the trailer 116 to rest on top of the rub rail 114 using gravity, without requiring tools or clamps or other devices.

An exemplary rub rail 114 as typically used for flatbed trailers, may comprise a heavy metal flat rail three inches (7.5 cm) wide and 3/16 inch (0.5 cm) thick, spaced from the edge of the flatbed by two inches (5 cm) and welded to the edge of the flat bed using periodic spacers at typically two foot (60 cm) intervals. In practice, dimensions are not standardized and may vary. The rub rail 114 may run partially along the edge or may have gaps. A typical rub rail 114 and flatbed 112 may be steel or aluminum or alloy.

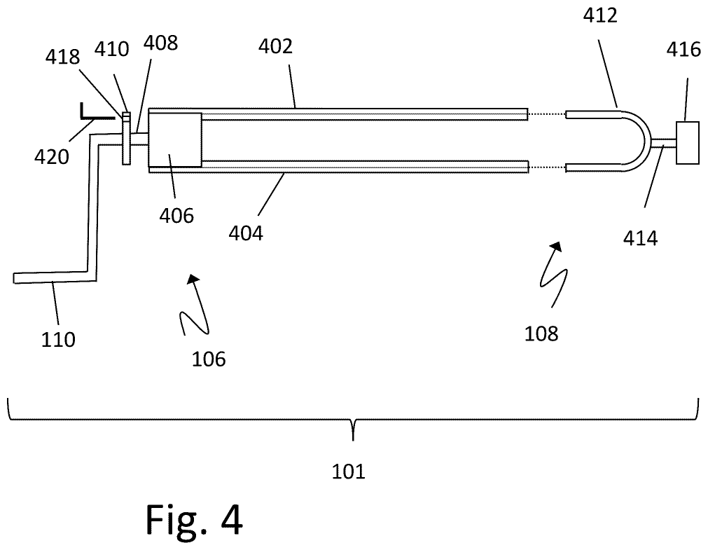

The tarp roller device 100 further comprises a tarp rotator assembly 101 (see FIG. 4) comprising a rotator fork unit 106, tine coupling unit 108, and crank with handle 110. The tarp rotator assembly 101 may be mounted onto the arms 102, 104 by inserting a shaft at each end of the tarp rotator assembly 101 in the slots 118 in the arms 102, 104. Pins 124, 126 are provided that may be released to lock the tarp rotator assembly 101 into the respective transfer slots 118, while allowing rotation of the tarp rotator assembly 101.

In operation, a tarp may be inserted into the tarp rotator assembly 101 and the crank 110 used to rotate the tarp rotator assembly 101 to roll the tarp around the rotator assembly 101. When rolling is complete, the pins 124, 126 may be retracted to allow the tarp rotator assembly 101 and tarp to be transferred to the flatbed 112 surface.

It may be appreciated that the device 100 may be symmetrical right to left such that the tarp rotator assembly 101 may be installed with the handle 110 end on the right or on the left, allowing operation by right handed or left handed operators. For example, the first arm 102 may be on the right and second arm 104 may be on the left. The handle 110 in FIG. 1 is shown on the right as viewed facing the truck bed 112 from the rotator assembly 101. The rotator assembly 101 may be flipped and installed with the handle on the left.

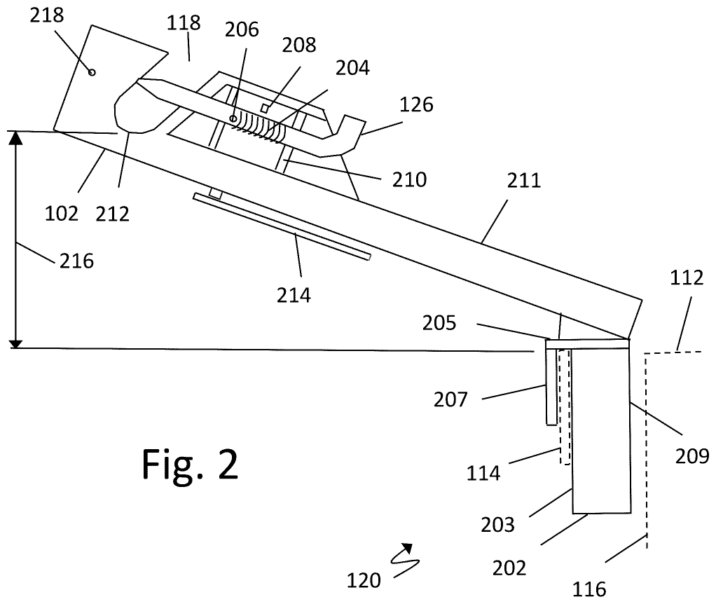

FIG. 2 is a side view of an exemplary first arm assembly 102 of the device. A second arm assembly 104, also shown in FIG. 1, is preferably a right-left mirror image of the first arm assembly 102, but may alternatively be a duplicate of the first arm. Referring to FIG. 2, the first arm assembly 102 comprises a supporting bar 211 having two ends, a proximal end close to the trailer 112 and a distal end away from the trailer 112.

The mounting structure 120 comprises a top plate 205, a forward lip 207 and a mounting bar 202. The top plate 205 may extend horizontally to rest on the top of the rub rail 114. The top plate may be attached to the support bar 211 at the proximal end of the support bar 211.

The forward lip 207 is attached to the top plate 205 at a forward side or edge of the top plate 205. The mounting bar 202 is attached to the top plate 205 toward a rear side, proximal to the trailer 112. The forward lip 207 and mounting bar 202 form a space therebetween for fitting over the rub rail 114. The mounting assembly 120 may be placed over the rub rail 114 with the top of the rub rail 114 resting on the bottom of the top plate 205 and between the front lip 207 and mounting bar 202.

The space between the forward lip 207 and mounting bar 202 may be a loose fit to allow for variations among rub rail dimensions in the field. Further, the device 100 may tilt as a result of the loose fit such that the mounting bar 202 may contact the side 116 of the trailer 112 in some cases. Thus, the mounting structure may adapt to a wide range of rub rail installations in the field.

In one embodiment, the top plate 205 and lip 207 may be fabricated together from a length of angle material and the vertical bar 202 may be rectangular tubing. The angle material and tubing may be welded together and welded to the support bar 211. The mounting structure 120 may be steel, aluminum, alloy, or plastic and may be fabricated in parts or unitary casting or other methods known in the art.

Relative terms including front, rearward, vertical, top and bottom are terms of convenience and refer to directions on the drawings or to directions with the device installed on a trailer. Proximal and distal refer to relative proximity to the trailer when installed.

In one embodiment, the tarp roller device 100 may be constructed to hold the tarp rotator 101 and the finished rolled tarp offset from the side 116 of the trailer 112, away from the trailer and above the level of the flatbed of the trailer 112. In particular, the tarp rotator assembly 101 bearing surface 212 may be positioned at least one foot (30 cm) horizontally from the forward lip 207 of the mounting structure 120. Further, the tarp rotator bearing surface 212 may be at an elevation 216 least four inches (10 cm), preferably between 2 and 24 inches (5 and 60 cm) vertically above the top plate 205 of the mounting structure 120. Other positions may be chosen as desired, including over the trailer bed and including lower than the level of the trailer bed.

Referring again to FIG. 2, the distal end of the first arm assembly 102, i.e., the end away from the trailer 112, includes a holding structure for supporting the tarp rotator assembly 101. The supporting structure may include a portion forming a slot 118 for receiving a shaft portion of the tarp rotator assembly 101 and a support surface 212 for supporting the shaft. (See FIG. 4 for the two shafts.) The support surface 212 may be sufficiently rounded and smooth to allow rotation of the shaft in operation. Alternatively, a rotational bearing may be included (not shown) if desired, preferably installed on the shaft. The slot 118 is shown fabricated at an angle tilted toward the trailer 112 to facilitate transfer of the rolled tarp to the trailer bed. The slot angle may be preferably between 20 and 70 degrees from horizontal, i.e., relative to the mounting structure 120 top plate 205.

Referring further to FIG. 2, the distal portion of arm 102 further includes a locking pin (also referred to as release pin) 126 to retain the tarp rotator shaft within the slot 118 during operation. The locking pin 126 operates with two support webs 210, a spring 204 and tab 208. A roll pin 206 extends outside the locking pin 126 to engage the spring 204. The roll pin 206 may also engage the tab 208 to keep the locking pin 126 retained in release position. The locking pin 126 slides through holes in the support webs 210. The spring 204 forces the locking pin 126 toward the distal side of the slot 118 to a locking position to retain the shaft of the tarp rotator assembly 101. The locking pin 126 may be pulled back and rotated so that the roll pin 206 extension rests on the tab 208 at a release position to allow insertion and removal of the shaft of the tarp rotator assembly 101.

It may be appreciated that other structures may be used for attaching and releasing the shaft of the tarp rotator assembly.

The arm assembly 102 may further include an optional stop mechanism or counter rotation feature 214. The counter rotation feature 214 may be a stop bar 214 that may be rotated into position to stop counter rotation of the crank and handle 110 when the rolling is completed. The stop bar 214 may be attached to at least one arm 102, 104 with a rotatable fastening, for example a shoulder bolt. A stop may be provided on the arm or bar to hold the stop bar 214 at a perpendicular angle with respect to the arm to prevent back-up (counter rotation) of the crank and handle 110.

Alternatively, a ratchet and pawl, or one-way bearing may be installed on at least one shaft 408, 414 of the tarp rotator assembly 101 to provide the single direction rotation feature.

In a further variation, a stop pin may engage the arm 102 through a hole 218 and a disk attached to the rotator shaft as further described with reference to FIG. 4.

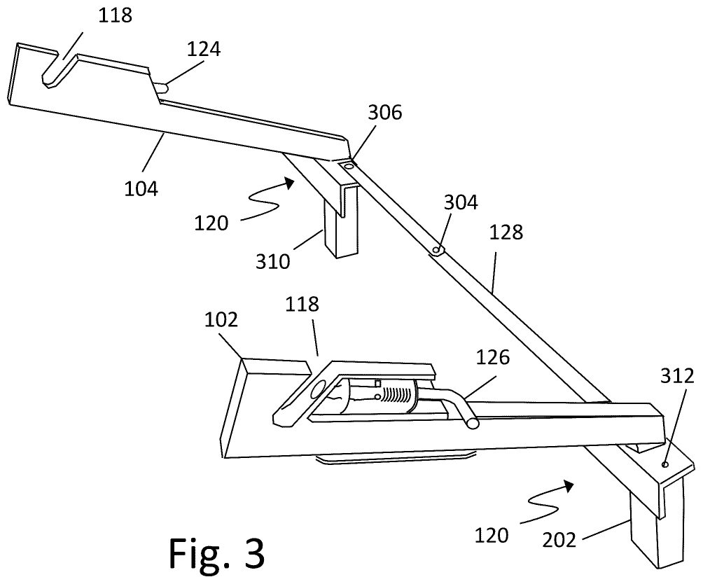

FIG. 3 is a perspective view of an exemplary frame structure of the device. Referring to FIG. 3, the frame structure comprises the first arm assembly 102, second arm assembly 104 and a spacer link 128. The first arm 102 is shown with the locking pin 126 in the retracted position allowing the transfer slot 118 to receive the shaft 408, or 414 of the rotator assembly 101 shaft. The spacer link 128 is provided to establish the distance between the proximal ends of the first arm 102 and second arm 104 so that the two arms are parallel when the tarp rotator assembly 101 is installed. The spacer link 128 is attached to each mounting structure 120 by a freely rotatable coupling 306. The spacer link includes two parts joined by an additional rotatable coupling 304. The rotatable couplings allow the link segments and arms 102, 104 to be folded for storage without disassembly. Alternatively, removable couplings may be provided, but would result in more separate items to be stored with a risk of losing an item.

In a further alternative, the spacer link 128 may be attached to other locations on the arms. For example, the spacer link may be attached to the bar 211 portion of the arm 102 near the proximal end. Further, it may be noted that the spacer link 128 may be optional. The rotator assembly 101 may be used as a gauge to place the two arms 102, 104 in position in the rub rail without using a spacer link 128.

FIG. 3 also shows a hole 312 for installation of an S-hook to be used for folding the tarp as described further herein.

FIG. 4 is an exploded side view of the tarp rotator assembly. Referring to FIG. 4, the tarp rotator assembly 101 comprises a rotator fork unit 106 and a tine coupling unit 108.

The rotator fork unit 106 comprises two tines 402, 404 connected to a hub 406 and the hub 406 connected to a shaft 408. The shaft 408 having an end stop 410 and extended to a crank with a handle 110. In one embodiment, the components may be joined by welding. Alternative constructions and connections may be used including but not limited to screws, bolts, glue, rivets, casting, or other techniques as desired. The tines 402, 404 may be rigidly attached to the hub 406 and typically run parallel, sufficiently parallel for sliding operation with the tine coupling unit 108. The tines are spaced to allow insertion of the tarp in the fan fold configuration. A spacing of 3 inches (7.5 cm) may be suitable for a range of typical tarps. A preferred range of spacing may be from one inch to eight inches 2.5 cm to 20 cm), more preferred from two to six inches (5 cm to 15 cm).

The tines are shown equal length, but may be different lengths. The tines are shown equal in width, but may be of unequal width. The surface of the tines for contact with the tarp may be smooth to allow easy sliding removal of the tarp rotator from the finished rolled tarp.

In FIG. 4, the shaft 408 is shown centered between the tines. In an alternative embodiment, the shaft 408 may be offset from center or aligned with one tine.

In one variation, the end stop 410 may include at least one hole 418, preferably multiple holes around the circumference to allow insertion of a stop pin 420 through one of the holes 418 and into a hole 218 in the arm 102 to stop the rotation and hold position of the rotator 101 to allow wrapping a cord around the rolled tarp without unwanted rotation of the rolled tarp.

The tine coupling unit 108 comprises a U-shaped rod 412 connected to a shaft 414 and end stop 416. Alternatively, the U-shaped rod feature may be two parallel rods welded to a cross bar. The components may be welded together or alternatively fabricated as desired. The tines 402, 404 of the rotator fork unit 106 and U-shaped rod 412 may be adapted so that the U-shaped rod ends 412 may be inserted into the tines 402, 404 with a slip fit. The length of the insertion may be sufficient to provide support for a fully loaded tarp when in use. For example, the tines may be square tubing with ⅝ inch (16 mm) spacing inside and the U-shaped feature may be round rod with ⅝ inch (16 mm) outside diameter. The tubing and rod dimensions may allow a slight clearance to permit easy slip fit of the rod into the tines. The rod ends may slip, for example, four inches (10 cm) inside the tines. The dotted lines of FIG. 4 indicate the insertion of the U-shaped rod into the tines.

In an alternative embodiment, the U-shaped rod may be replaced with tubing adapted to fit over the tines and slip over the tines to support the tines.

In a further variation, the tine coupling unit may have a single coupling end to couple to a single tine.

In one exemplary embodiment, the assembled length of the tarp rotator assembly 101 from the crank shaft 408 to the end shaft 414 may be three feet (120 cm). Any desired length may be used. Preferred lengths may be between two feet and five feet (60 cm to 150 cm).

In a further variation, the tines 402, 404 may be shorter and the time coupling unit 412 may be longer than shown in FIG. 4 to result in a more compact disassembled configuration for easier storage.

In one embodiment, the rotator assembly shafts 408, 414 may be round steel or other materials suitable for direct rotational bearing contact with the support arm 102, 104. Alternatively, bearings or bearing sets including ball bearing sets may be installed on the shafts (not shown). The end stops 410, 416 keep the shaft portion 408, 414 within the support arms 102, 104. The crank and handle 110 may be any desired length for a convenient cranking radius. An exemplary length may be 18 inches (45 cm), preferably between 12 and 24 inches (30 cm and 60 cm).

In operation, the tine coupling unit 108 may be inserted into the rotator fork unit 106 and the resulting assembly 101 installed on the arms 102, 104 with the shafts 408, 414 inserted into the slots 118.

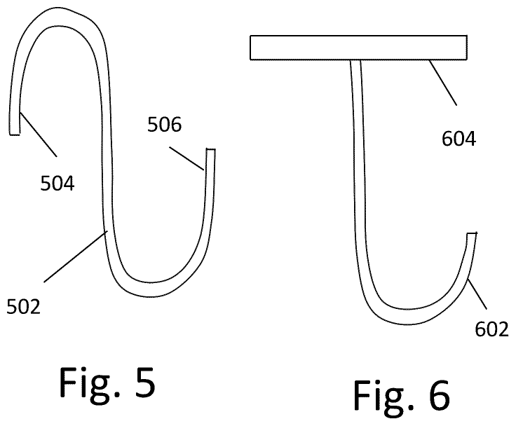

FIG. 5 is a side view of an exemplary S-hook. The S-hook 502 may be used to assemble the tarp in a pre-folding operation to form a length-wise fan fold configuration of the tarp. The tarp is provided with gromets at periodic intervals along the edge. One end 504 of the S-hook 502 is inserted into the hole 312 provided in one arm attachment (see FIG. 3). Gromets are then inserted in sequence in the other end 506 of the S-hook 502. Alternative shapes other than the S-hook may be fabricated that perform the same function of producing a secure anchor point for assembling the gromets.

Alternatively, the S-hook may be affixed to any convenient secure location, for example, the S-hook may be hooked to the rub rail, i.e., inserted into the space between the rub rail and the side of the truck or trailer.

FIG. 6 is a side view of an exemplary T-handle hook. The T-handle hook 602 is used to assemble gromets at an opposite end of the tarp from the S-hook. An exemplary T-handle hook 602 may be fabricated by bending steel bar material to a hook shape and attaching the hook shape to a handle 604, in one embodiment, the steel bar hook shape may be welded to a section of steel tubing for the handle. Other materials and fabrication methods may be used including other alloys, plastics, casting, screws, bolts, swaging, as are known in industry.

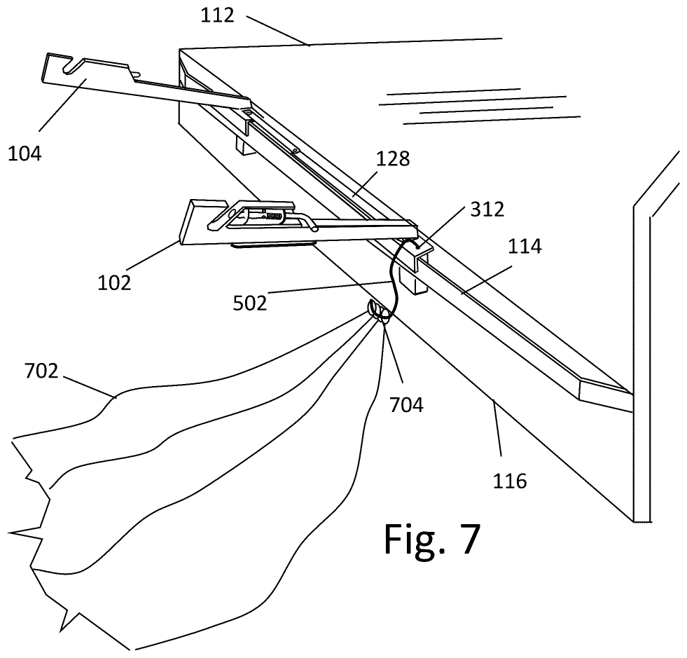

FIG. 7 is a view of the S-hook with tarp and gromets installed on a trailer rub rail. Referring to FIG. 7, FIG. 7 shows the arm assemblies 102, 104 installed on a flatbed trailer 112 having a rub rail 114. The mounting ends of the arm assemblies 102, 104 are installed on the rub rail 114 and side of the truck bed 112, 116. The two arms 102, 104 are spaced in accordance with the spacer link 128. The S-hook 502 is inserted into the hole 312 provided in the mounting base 120 of the arm assembly 102.

It may be observed that the S-hook attaches to the trailer and extends laterally beyond the edge of the trailer to allow the tarp to hang freely without interference from the trailer. In particular, gromet attachment feature 506 of the S-hook 502 may be greater than two inches (5 cm) from the mounting structure 120, preferably greater than four inches (10 cm) from the mounting structure 120 when the S-hook is installed.

The tarp 702 is first laid on the ground and spread out by the side of the trailer 112. One edge, preferably on a lengthwise end (short side) is placed near the tarp roller 100. Gromets 704 along the edge are then inserted in sequence on the distal end 506 of the S-hook 502. Depending on gromet spacing, every gromet, or every other gromet, or other spacing may be used as desired. The resulting fold between gromets should be less than the length of the tines 402 on the rotator fork unit 106.

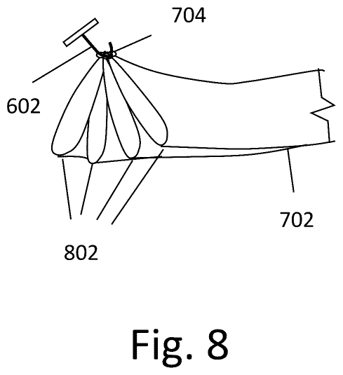

FIG. 8 is a view of an exemplary accordion fold stretch configuration. FIG. 8 shows the gromets 704 on the distal end of the tarp 702 (the end away from the trailer 112) being assembled onto the T-handle hook 602. The gromets 704 are assembled in matching sequence to the gromets on the S-hook.

The resulting folds 802 are illustrated, and may be referred to as an accordion fold configuration, or alternatively as a fan-fold configuration.

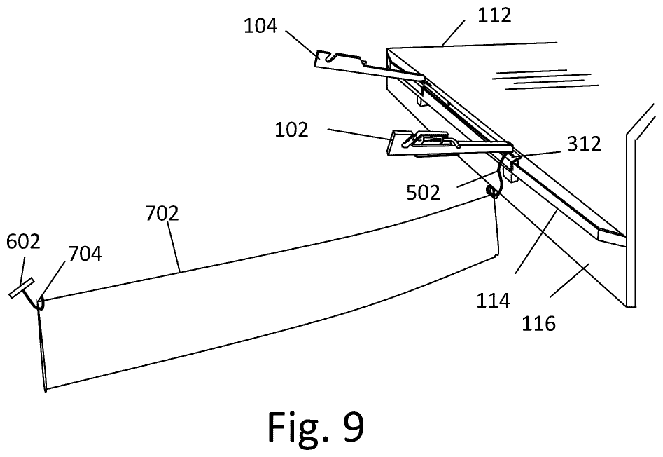

FIG. 9 is a view of the tarp stretched between the S-hook and T-handle hook. When the desired gromets are assembled, the tarp 702 may be stretched, hanging from the two hooks 502, 602. The folds will then become aligned between the two ends of the tarp 702. The tarp 702 may be shaken or swayed to help alignment of the folds. The fan fold tarp 702 may then be placed flat on the ground. The S-hook and T-hook may be removed from the tarp.

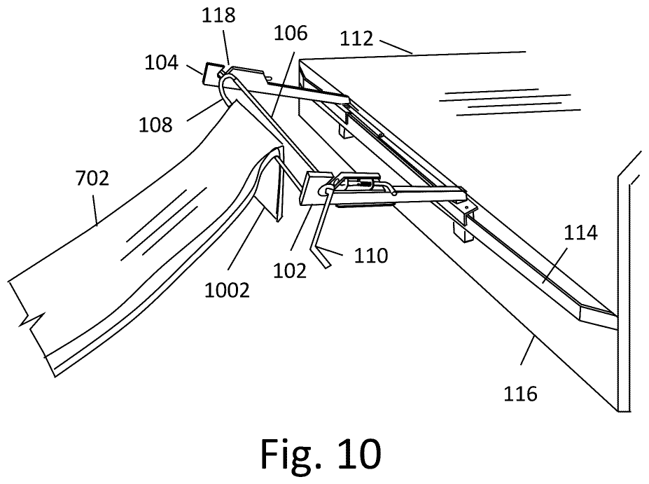

FIG. 10 is a view of the device with tarp inserted showing drape section. Referring to FIG. 10, FIG. 10 shows the arms 102, 104 of FIG. 9 with the rotator fork assembly 101 of FIG. 4 installed. The lock pins 126, 124 are in lock position to capture the fork shaft 408, 414 within the slots 118, while allowing turning of the tarp rotator assembly 101. The fan folded tarp 702 produced as in FIG. 9 is fed through the opening between the two tines 402, 404 and hangs down freely 1002. The handle 110 may then be turned to wind the tarp 702 around the tarp rotator tines 402, 404 of the rotator fork unit 106. The tarp 702 rests on one tine 404 and a section 1002 of the tarp 702 hangs freely. As the rotator assembly is turned, the tarp wraps around the two tines 402, 404 and forms a roll around the tines. It may be appreciated that rolling the tarp onto the rotator assembly continuously lifts a portion of the tarp up to the rotator assembly level, thus gaining a kind of mechanical advantage by not having to lift the entire tarp from ground to flatbed level in one step. Thus, it may be appreciated that the rolling process simultaneously accomplishes the rolling of the tarp and the lifting of the tarp to trailer level.

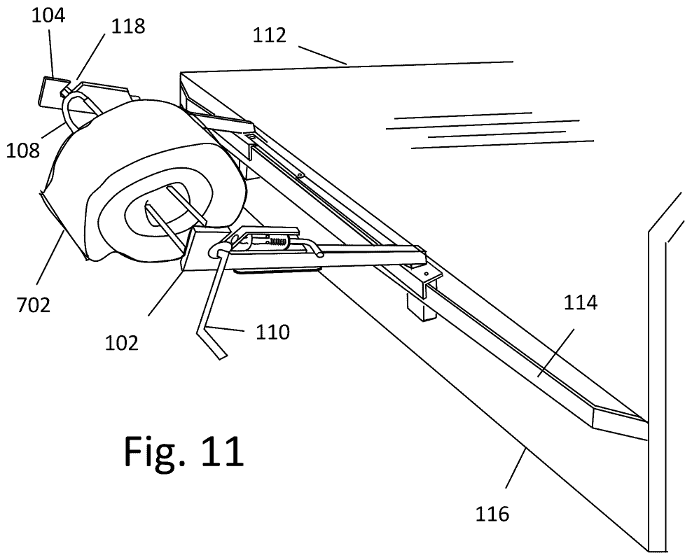

FIG. 11 is a view of the exemplary tarp roller device with the tarp rolling completed. Referring to FIG. 11, the tarp rotating assembly of FIG. 9 is depicted with the tarp rolling completed and the tarp supported by the rotator arms 102, 104. The arm pins 124, 126 may then be pulled back and set to open the slots 118 and allow the tarp rotator shafts 408, 414 to slip through the slots 118 and thus allow the rotator assembly 101 with tarp 702 to be removed.

In the rolled configuration, the tarp may be wrapped with an elastic strap or rope or other device to prevent unrolling while moving and storing the tarp.

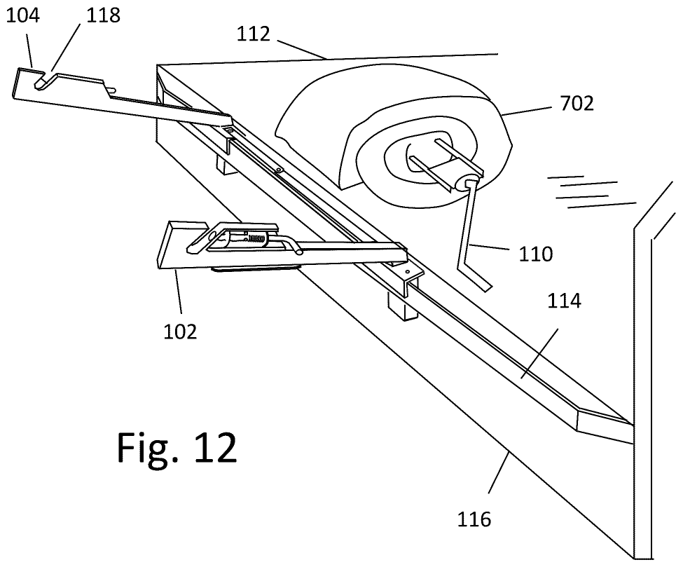

FIG. 12 is a view of the rolled tarp and rotator assembly removed from the arms of the frame and placed on the flatbed. It may be noted that the tarp 702 in FIG. 11 is substantially at the level of the flatbed surface 112 so that relatively little lifting need be performed to move the tarp to the flatbed surface 112 as in FIG. 12. In particular, no bending to ground level is needed, thus, relieving a source of back strain. Once moved, the tarp rotator assembly 101 may then be separated by pulling on the ends of the rotator assembly 101 to slip the tine coupling unit 108 out of the fork tines 402, 404 and pull both the tine coupling unit 108 and rotator fork unit 106 out of the center of the rolled tarp 702. The tarp may then be relocated for storage.

### REFERENCES

The following is a listing of the references used in the drawings.
100 tarp roller device
101 tarp rotator assembly
102 first arm
104 second arm
106 rotator fork unit
108 tine coupling unit
110 crank and handle
112 flatbed trailer or truck
114 rub rail
116 side of trailer
118 transfer slot
120 first mounting structure
122 second mounting structure
124 first locking pin
126 second locking pin
128 spacer link
202 mounting bar
203 front surface of vertical member mounting bar
204 spring
205 Top plate
206 roll pin
207 front lip
208 tab
209 rear surface of vertical member mounting bar
210 support rib
211 support bar
212 shaft support or bearing support
214 counter rotation stop bar
216 vertical distance
218 hole for receiving stop pin
304 spacer link joint
306 mounting to spacer link joint
310 second vertical mounting bar
312 hole for attachment of S-hook
402 first tine
404 second tine
406 hub
408 rotating fork shaft
410 rotating fork end stop
412 tine coupling rod
414 tine coupling unit shaft
416 tine coupling unit end stop
418 hole for inserting stop pin
420 stop pin
502 S-hook
504 first end of S-hook
506 second end of S-hook
602 T-handle hook
604 T-Handle
702 Tarp
704 Gromet
802 Tarp folds
1002 tarp drape

What is claimed is:

1. A device for assisting in the preparation of a tarp for storage comprising:
a mounting frame and a tarp rotator assembly;
said mounting frame for mounting the device on a trailer;
said mounting frame having a releasable attachment for receiving and attaching said tarp rotator assembly;
said releasable attachment allowing for rotation of said tarp rotator assembly when said tarp rotator assembly is attached to said mounting frame;
said tarp rotator assembly comprising an end shaft unit comprising a rotatable shaft for operating with at least one releasable attachment of said mounting frame;
said end shaft unit being removable from said tarp rotator assembly;
said tarp rotator assembly having a handle for manually rotating said tarp rotator assembly;
whereby said tarp may be inserted into said tarp rotator assembly and said tarp rotator assembly may be rotated to roll said tarp around said tarp rotator assembly to produce a rolled tarp; said rolled tarp together with said tarp rotator assembly may then be released from the mounting frame and transferred to said trailer; whereupon the tarp rotator assembly may be removed from the tarp, leaving a rolled tarp ready for storage.

2. The device of claim 1, wherein the mounting frame comprises two arms, each said arm having a first end proximal to said trailer adapted for mounting on said trailer and a second end, distal from said trailer, said second end including said releasable attachment.

3. The device of claim 2, wherein said first arm and said second arm are extended outward from an edge of said trailer.

4. The device of claim 2, wherein said releasable attachment is positioned above said top of said rub rail when said device is mounted on said rub rail.

5. The device of claim 1, wherein said tarp rotator assembly comprising at least two tines spaced from one another sufficiently to receive at least one end of a tarp insertable between said at least two tines of said tarp rotator assembly.

6. The device of claim 5, wherein said at least two tines are substantially parallel to one another.

7. The device of claim 6, wherein said tarp rotator assembly comprising a rotator fork unit and tine coupling unit, said tine coupling unit removably attachable to said rotator fork unit.

8. The device of claim 7, wherein the tarp rotator assembly may be assembled to the mounting frame with the handle to the right or to the left of the mounting frame, thereby allowing operation by right handed operators or left handed operators.

9. The device of claim 1, wherein the trailer includes a rub rail spaced from an edge of the trailer and forming a space between the rub rail and the trailer; said mounting assembly adapted for mounting said device on said trailer by resting said mounting assembly on a top of said rub rail and fitting between said rub rail and said edge of said trailer.

10. The device of claim 1, wherein said tarp has a first set of gromets displaced along a first side; said device including an s-hook attachable to said mounting frame for receiving said gromets of said tarp; whereby said first set of gromets of said tarp may be placed on said s-hook in sequence to produce an accordion fold configuration of said tarp, said accordion fold configuration may then be inserted into the tarp fork assembly for rolling to the rolled tarp configuration.

11. The device of claim 10, wherein said tarp includes a second set of gromets along a second side opposite said first side, said device including a t-handle hook, said t-handle hook having a hook shaped part attached to a handle, said t-handle hook configured to receive said second set of gromets to stretch the tarp between said s-hook and said t-handle hook to form the accordion fold configuration.

12. The device of claim 1, wherein said releasable attachment forms a transfer slot tilted toward the trailer mounting at an angle from 20 degrees to 70 degrees from horizontal, thereby allowing the tarp roller assembly with rolled tarp to be transferred onto the trailer, whereupon the tarp roller assembly may be removed from the tarp.

13. The device of claim 12, wherein said transfer slot has an angle between 30 and 60 degrees from horizontal.

14. The device of claim 13, wherein said releasable attachment further including a release pin to constrain the tarp rotator assembly within the releasable attachment in a locked position and release the tarp rotator assembly in a release position.

15. The device of claim 1, wherein said device includes a stop mechanism to prevent rotation of said tarp rotator assembly to facilitate tying the rolled tarp.

16. The device of claim 15, wherein said stop mechanism comprises a ring having holes with a stop pin, or a rachet with a pawl.

17. The device of claim 1, said mounting frame comprising a first arm and a second arm connected by a spacer link therebetween, said first arm and said second arm having a proximal end for mounting on said trailer, said spacer link attached to said first arm at said proximal end and to said second arm at said respective proximal end.

18. The device of claim 17, wherein the spacer link is attached to the first arm and the second arm using rotatable coupling to allow the device to be folded while remaining connected for storage.

19. A method for assisting in the preparation of a tarp for storage comprising:
mounting a mounting frame to a trailer, wherein the mounting frame comprises two arms, each said arm having a first end proximal to said trailer adapted for mounting on said trailer and a second end, distal from said trailer, said second end including a releasable attachment;
said releasable attachment for receiving and attaching a tarp rotator assembly; said tarp rotator assembly rotatable in said attachment;
attaching said tarp rotator assembly to said mounting frame; said tarp rotator assembly having an opening for receiving and holding one end of a tarp, said tarp rotator assembly having a handle for rotating said tarp rotator assembly;
preparing said tarp by folding said tarp with multiple lengthwise folds to produce a pre-folded tarp thereby reducing a width of the tarp to fit the tarp rotator assembly;
inserting one end of the pe-folded tarp into the tarp rotator assembly;
rotating the tarp rotator assembly until the tarp is fully rolled on the tarp rotator assembly;
releasing the tarp rotator assembly with the rolled tarp thereupon;
transferring the tarp rotator assembly with tarp thereupon to a storage location;
separating the tarp rotator assembly from the tarp, leaving the rolled tarp.

20. The method of claim 19, wherein the preparing step includes the steps:
placing said tarp open and proximal to the mounting frame; said tarp having gromets spaced on a first side and on a second side opposite said first side;
attaching an attachment rod in said mounting frame;
attaching said gromets from said first side of said tarp to said attachment rod;
producing a t-handle rod and attaching said gromets from said second side of said tarp to said t-handle rod;
stretching the tarp between said mounting frame and said t-handle rod, allowing tarp folds to fall and form said pre-folded tarp.
